(19) United States
(12) Patent Application Publication
(10) Pub. No.: US 2023/0326441 A1
(43) Pub. Date: Oct. 12, 2023

(54) Silent Detection of Open or Short Connections to a Piezoelectric Device

(71) Applicant: Microchip Technology Incorporated, Chandler, AZ (US)

(72) Inventor: Jonathan Corbett, Havertown, PA (US)

(73) Assignee: Microchip Technology Incorporated, Chandler, AZ (US)

(21) Appl. No.: 18/131,597

(22) Filed: Apr. 6, 2023

Related U.S. Application Data
(60) Provisional application No. 63/328,768, filed on Apr. 8, 2022.

(51) Int. Cl. G10K 9/122; H04R 17/10; H04R 17/00

(52) U.S. Cl. CPC G10K 9/122; H04R 17/10; H04R 17/005

(57) ABSTRACT

An apparatus includes a test circuit to receive signals from a piezoelectric horn and a control circuit to determine whether to operate the apparatus in a silent test mode or a normal mode. The apparatus includes a control circuit to, based on a determination to operate in the normal mode, enable a driver circuit to drive the piezoelectric horn so as to output sound when activated by the driver circuit. The test circuit is to, based on a determination to operate in the silent test mode, cause the piezoelectric horn to generate a piezoelectric response, wherein the piezoelectric horn is silent while generating the piezoelectric response during the silent test mode, and cause evaluation of whether or not the piezoelectric horn is working correctly based upon the received signals from the piezoelectric horn.

### PRIORITY

The present application claims priority to U.S. Provisional Patent Application No. 63/328,768 filed Apr. 8, 2022, the contents of which are hereby incorporated in their entirety.

### FIELD OF THE INVENTION

The present disclosure relates to testing of electronic devices and, more particularly, to detection of open or short connections to a piezoelectric device.

### BACKGROUND

Various devices use piezoelectric devices, such as horns. For example, a smoke detector may use a horn that generates an audible signal. These various devices may be tested from time to time for various reasons. For example, smoke detectors may be tested for open and short connections to circuitry therein to ensure continued smoke detection alerts of an area. Driving the piezoelectric device with a test signal results in an audible sound being produced from the piezoelectric device.

Inventors of examples of the present disclosure have discovered methods and systems of testing such electronic devices for open or short connections that do not produce an audible sound.

### BRIEF DESCRIPTION OF THE DRAWINGS

FIG. 1 is an illustration of an apparatus for detection of open or short circuited connections (also called simply “short”) to a piezoelectric device, according to examples of the present disclosure.

FIG. 2 is an illustration of another apparatus for detection of open or short connections to a piezoelectric device, according to examples of the present disclosure.

FIG. 3 is an illustration of yet another apparatus for detection of open or short connections to a piezoelectric device, according to examples of the present disclosure.

FIG. 4 is an illustration of still another apparatus for detection of open or short connections to a piezoelectric device, according to examples of the present disclosure.

FIG. 5 is an illustration of an apparatus for detection of open or short connections to a piezoelectric device, according to examples of the present disclosure.

FIG. 6 is a more detailed illustration of example implementations of a driver circuit, generator circuit, and control circuitry, according to examples of the present disclosure.

FIG. 7 is a more detailed illustration of example implementations of test circuits and control circuitry, according to examples of the present disclosure.

FIGS. 8 and 9 are illustrations of possible responses for test code 0100, according to examples of the present disclosure.

FIGS. 10 and 11 are illustrations of possible responses for test code 0111, according to examples of the present disclosure.

FIGS. 12 and 13 are illustrations of possible responses for test code 1001, according to examples of the present disclosure.

FIGS. 14 and 15 are illustrations of possible responses for test code 1010, according to examples of the present disclosure.

FIGS. 16 and 17 are illustrations of possible responses for test code 1101, according to examples of the present disclosure.

FIGS. 18 and 19 are illustrations of possible responses for test code 1110, according to examples of the present disclosure.

FIG. 20 is an illustration of operation of a method for detection of open or short connections to a piezoelectric device, according to examples of the present disclosure.

FIG. 21 is an illustration of operation of another method for detection of open or short connections to a piezoelectric device, according to examples of the present disclosure.

FIG. 22 is an illustration of operation of yet another method for detection of open or short connections to a piezoelectric device, according to examples of the present disclosure.

FIG. 23 is an illustration of operation of still another method for detection of open or short connections to a piezoelectric device, according to examples of the present disclosure.

### DETAILED DESCRIPTION

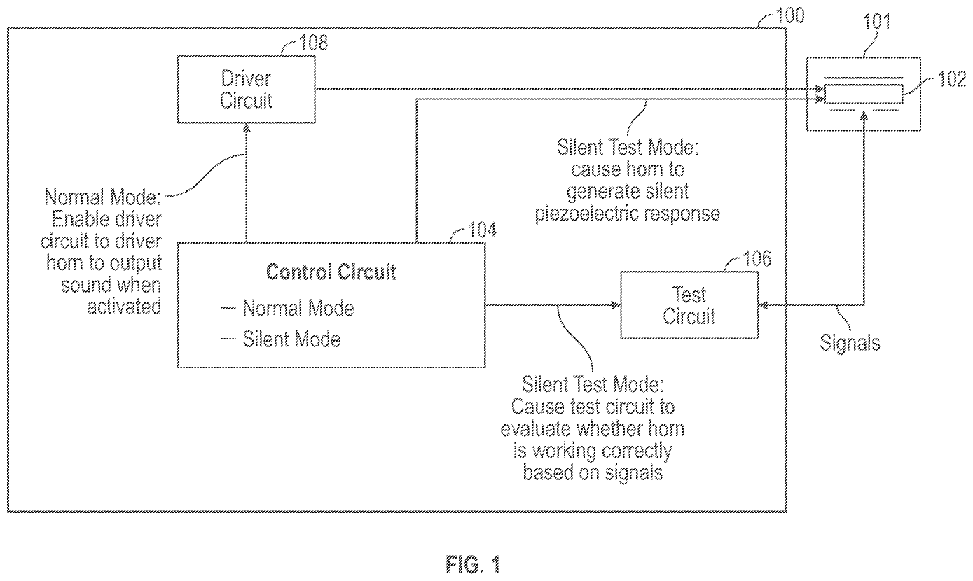

FIG. 1 is an illustration of an apparatus 100 for detection of open or short circuited connections (also called simply “short”) to a piezoelectric device, according to examples of the present disclosure.

Apparatus 100 may include a control circuit 104, a test circuit 106, and a driver circuit 108. Each of control circuit 104, test circuit 106, and driver circuit 108 may be implemented in any suitable manner, such as by analog circuitry, digital circuitry, control logic, instructions in a non-transitory medium (not shown) for execution by a processor (not shown), digital logic circuits programmed through hardware description language, application specific integrated circuits (ASIC), field programmable gate arrays (FPGA), programmable logic devices (PLD), or any suitable combination thereof, whether in a single unit or spread over several units.

Apparatus 100 may be configured to detect open or short connections to any suitable piezoelectric device. The piezoelectric device may include any suitable device for generating sound using a piezoelectric response or effect. The piezoelectric response may arise from electric charge accumulating in a solid material, which may include a linear electromechanical interaction between mechanical and electrical states in the material of the device without inversion symmetry. The voltage arising from the accumulation of charge may be converted in the piezoelectric device to mechanical movement of a metallic diaphragm. The piezoelectric device may be implemented by, for example, a piezoelectric horn 102. Piezoelectric horn 102 may be implemented within a piezoelectric horn circuit 101, which may include any other suitable connections or components, as discussed in further detail below. Such components may be used, for example, for the conditioning of signals to or from horn 102. Piezoelectric horn circuit 101 and horn 102 may include any suitable number and kind of terminals, such as an HB terminal (also referred to as a metal electrode or diaphragm), an HS terminal (also referred to as a ceramic electrode), a FEED terminal, and a feedback (FB) terminal. An HB feedback (HBFB) terminal may interface to horn 102 but may exist outside of horn 102. The FB terminal may also be a ceramic electrode. The FEED terminal may interface to horn 102 but may exist outside of horn 102. The HBFB and FB terminals may interface out of piezoelectric horn circuit 101.

Horn circuit 101, horn 102, and apparatus 100 may be implemented within any suitable system and context. For example, horn circuit 101, horn 102, and apparatus 100 may be included fully or in part in a system, microcontroller, consumer device, electronic device, or any other suitable mechanism. Horn circuit 101, horn 102, and apparatus 100 may be included in, for example, a smoke detector, heat detector, carbon monoxide detector, alarm, security system, or any other context in which an audible response of horn 102 is to alert users to a condition. As such, horn 102 may be periodically tested to evaluate whether horn 102 is correctly functioning. Tests of whether horn 102 are correctly functioning may include tests of whether any terminals of horn 102 are short circuited or are open (not connected to an expected electrical connection). In various examples, the tests of horn 102 in the present disclosure may be performed silently, wherein during the test, horn 102 may be verified to be working correctly with regards to short circuits or open terminals without making an audible noise, which may be unexpected given that typical operation of horn 102 wherein a piezoelectric response is generated may, in normal operation and by design, cause an audible noise.

Test circuit 106 may be configured to receive signals from horn 102. Any suitable signals may be received from horn 102.

Control circuit 104 may be configured to determine whether to operate apparatus 100 in a silent test mode or in a normal mode. Based on a determination to operate in the normal mode, control circuit 104 may be configured to enable driver circuit 108 to drive horn 102 so as to output sound when apparatus 100 detects a designated external phenomena, such as smoke, heat, or carbon dioxide. This may be performed by an enable signal that enables driver circuit 108 to receive and respond to detection signals (not shown) from any suitable sensors. Control circuit 104 may be configured to, based on a determination to operate in the silent test mode, cause horn 102 to generate a piezoelectric response. Horn 102 may be silent while generating the piezoelectric response during the silent test mode. In various examples, the piezoelectric response may or may not be used to detect a short or open. Control circuit 104 may be configured to cause test circuit 106 to evaluate whether or not horn 102 is working correctly based upon the received signals from horn 102.

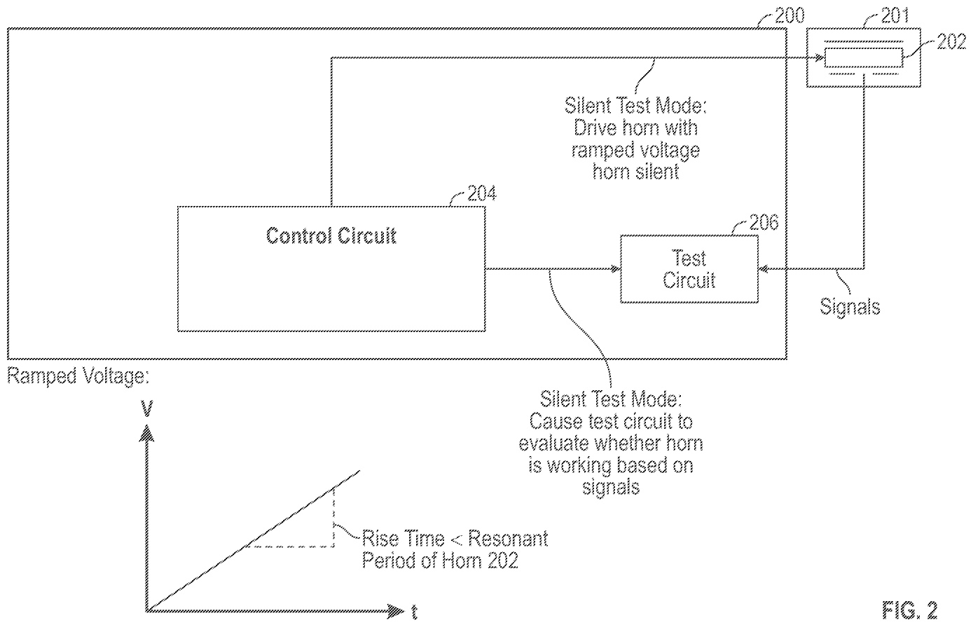

FIG. 2 is an illustration of another apparatus 200 for detection of open or short connections to a piezoelectric device, according to examples of the present disclosure.

Apparatus 200 may include a control circuit 204 and a test circuit 206. Each of control circuit 204 and test circuit 206 may be implemented in any suitable manner, such as by analog circuitry, digital circuitry, control logic, instructions in a non-transitory medium (not shown) for execution by a processor (not shown), digital logic circuits programmed through hardware description language, ASICs, FPGAs, PLDs, or any suitable combination thereof, whether in a single unit or spread over several units.

Apparatus 200 may be configured to detect open or short connections to any suitable piezoelectric device. The piezoelectric device may include any suitable device for generating sound using a piezoelectric response or effect. The piezoelectric response may arise from electric charge accumulating in a solid material, which may include a linear electromechanical interaction between mechanical and electrical states in the material of the device without inversion symmetry. The voltage arising from the accumulation of charge may be converted in the piezoelectric device to mechanical movement of a metallic diaphragm. The piezoelectric device may be implemented by, for example, a piezoelectric horn 202. Piezoelectric horn 202 may be implemented within a piezoelectric horn circuit 201, which may include any other suitable connections or components, as discussed in further detail below. Such components may be used, for example, for the conditioning of signals to or from horn 202. Piezoelectric horn 202 and piezoelectric horn circuit 201 may include any suitable number and kind of terminals, such as an HB terminal, an HS terminal, and an FB terminal. An HBFB terminal may be interfaced to horn 202 but may exist outside of horn 202 such as in horn circuit 201.

Horn 202, horn circuit 201, and apparatus 200 may be implemented within any suitable system and context. For example, horn 202, horn circuit 201, and apparatus 200 may be included fully or in part in a system, microcontroller, consumer device, electronic device, or any other suitable mechanism. Horn 202, horn circuit 201, and apparatus 200 may be included in, for example, a smoke detector, heat detector, carbon monoxide detector, alarm, security system, or any other context in which an audible response of horn 202 is to alert users to a condition. As such, horn 202 may be periodically tested to evaluate whether horn 202 is correctly functioning. Tests of whether horn 202 are correctly functioning may include tests of whether any terminals of horn 202 are short-circuited or are open circuited (not connected to an expected electrical connection). In various examples, the tests of horn 202 in the present disclosure may be performed silently, wherein during the test, horn 202 may be verified to be working correctly without making an audible response, which may be unexpected given that typical operation of horn 202 wherein a piezoelectric response is generated may, in normal operation and by design, cause an audible noise.

Test circuit 206 may be configured to receive signals from horn 202. Any suitable signals may be received from horn 202.

Control circuit 204 may be configured to determine whether to operate apparatus 100 in a silent test mode. Control circuit 204 may be configured to, based on a determination to operate in the silent test mode, drive horn 202 with a ramped voltage. Horn 202 may be silent while being driven with the ramped voltage during the silent test mode. The ramped voltage may have a rise time or a slope that is slower than a resonant period of horn 202, wherein the ramped voltage has a longer rise time than the resonant period. Control circuit 204 may be configured to cause test circuit 206 to evaluate whether or not horn 202 is working correctly based upon the received signals from horn 202 in response to, or substantially contemporaneously with the ramped voltage.

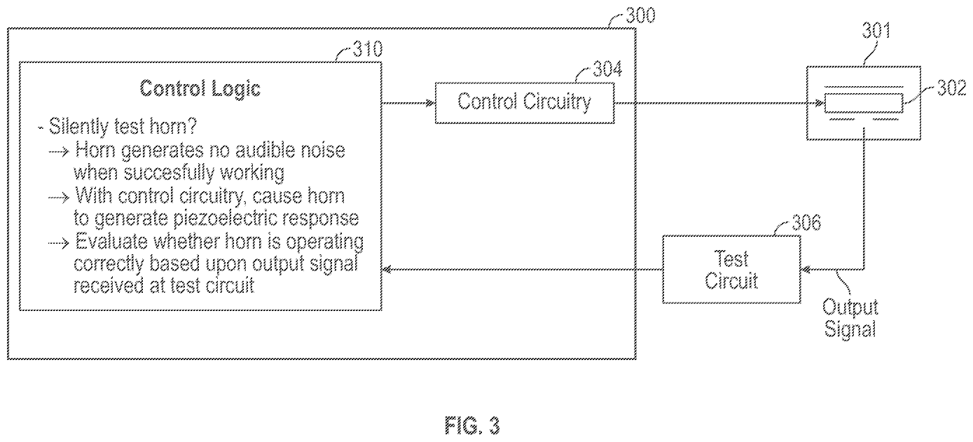

FIG. 3 is an illustration of yet another apparatus 300 for detection of open or short connections to a piezoelectric device, according to examples of the present disclosure.

Apparatus 300 may include a control logic 310 and control circuitry 304. Each of control logic 310 and control circuitry 304 may be implemented in any suitable manner, such as by analog circuitry, digital circuitry, control logic, instructions in a non-transitory medium (not shown) for execution by a processor (not shown), digital logic circuits programmed through hardware description language, ASICs, FPGAs, PLDs, or any suitable combination thereof, whether in a single unit or spread over several units. Control circuitry 304 may be represented or implemented by, for example, switches. Moreover, control circuitry 304 may be implemented within various elements (not shown) that perform functionality for apparatus 300. Control circuitry 304 may be implemented by any suitable mechanism to enable or disable, connect, or disconnect elements or functionality of apparatus 300.

Apparatus 300 may be configured to detect open or short connections to any suitable piezoelectric device. The piezoelectric device may include any suitable device for generating sound using a piezoelectric response or effect. The piezoelectric response may arise from electric charge accumulating in a solid material, which may include a linear electromechanical interaction between mechanical and electrical states in the material of the device without inversion symmetry. The voltage arising from the accumulation of charge may be converted in the piezoelectric device to mechanical movement of a metallic diaphragm. The piezoelectric device may be implemented by, for example, a piezoelectric horn 302. Piezoelectric horn 302 may be implemented within a piezoelectric horn circuit 301, which may include any other suitable connections or components, as discussed in further detail below. Such components may be used, for example, for the conditioning of signals to or from horn 302. Piezoelectric horn 302 may include any suitable number and kind of terminals, such as an HB terminal, an HS terminal, and an FB terminal. An HBFB terminal may be interface to horn 302 but may exist outside of horn 302.

Horn 302, horn circuit 301, and apparatus 300 may be implemented within any suitable system and context. For example, horn 302, horn circuit 301, and apparatus 300 may be included fully or in part in a system, microcontroller, consumer device, electronic device, or any other suitable mechanism. Horn 302, horn circuit 301, and apparatus 300 may be included in, for example, a smoke detector, heat detector, carbon monoxide detector, alarm, security system, or any other context in which an audible response of horn 302 is to alert users to a condition. As such, horn 302 may be periodically tested to evaluate whether horn 302 is correctly functioning. Tests of whether horn 302 are correctly functioning may include tests of whether any terminals of horn 302 are short-circuits or are open (not connected to an expected electrical connection). In various examples, the tests of horn 302 in the present disclosure may be performed silently, wherein during the test, horn 302 may be verified to be working correctly without making an audible noise, which may be unexpected given that typical operation of horn 302 wherein a piezoelectric response is generated may, in normal operation and by design, cause an audible noise.

Control logic 310 may be connected to control circuitry 304. Control logic 310 may be configured to determine whether to silently test horn 302. The silent test of horn 302 may cause no audible noise when horn 302 is successfully working. Control logic 310 may be configured to, based upon a determination to silently test horn 302, with control circuitry 304, cause horn 302 to generate a piezoelectric response. Control logic 310 may be configured to, based upon a determination to silently test horn 302, with control circuitry 304, evaluate whether or not horn 302 is working properly correctly based upon an output signal received from a test circuit 306, which in turn may receive an output signal from horn 302.

Test circuit 306 may be implemented in any suitable manner, such as by analog circuitry, digital circuitry, control logic, instructions in a non-transitory medium (not shown) for execution by a processor (not shown), digital logic circuits programmed through hardware description language, ASICs, FPGAs, PLDs, or any suitable combination thereof, whether in a single unit or spread over several units.

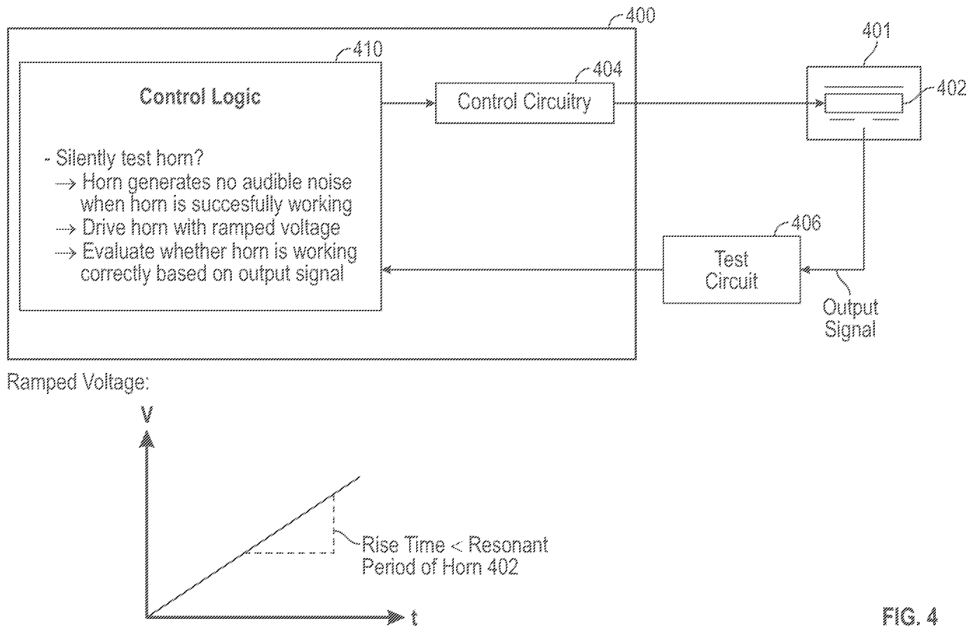

FIG. 4 is an illustration of still another apparatus 400 for detection of open or short connections to a piezoelectric device, according to examples of the present disclosure.

Apparatus 400 may include a control logic 410 and control circuitry 404. Each of control logic 410 and control circuitry 404 may be implemented in any suitable manner, such as by analog circuitry, digital circuitry, control logic, instructions in a non-transitory medium (not shown) for execution by a processor (not shown), digital logic circuits programmed through hardware description language, ASICs, FPGAs, PLDs, or any suitable combination thereof, whether in a single unit or spread over several units. Control circuitry 404 may be represented or implemented by, for example, switches. Moreover, control circuitry 404 may be implemented within various elements (not shown) that perform functionality for apparatus 400. Control circuitry 404 may be implemented by any suitable mechanism to enable or disable, connect, or disconnect elements or functionality of apparatus 400.

Apparatus 400 may be configured to detect open or short connections to any suitable piezoelectric device. The piezoelectric device may include any suitable device for generating sound using a piezoelectric response or effect. The piezoelectric response may arise from electric charge accumulating in a solid material, which may include a linear electromechanical interaction between mechanical and electrical states in the material of the device without inversion symmetry. The voltage arising from the accumulation of charge may be converted in the piezoelectric device to mechanical movement of a metallic diaphragm. The piezoelectric device may be implemented by, for example, a piezoelectric horn 402. Piezoelectric horn 402 may be implemented within a piezoelectric horn circuit 401, which may include any other suitable connections or components, as discussed in further detail below. Such components may be used, for example, for the conditioning of signals to or from horn 402. Piezoelectric horn 402 may include any suitable number and kind of terminals, such as an HB terminal, an HS terminal, and an FB terminal. An HBFB terminal may be interface to horn 402 but may exist outside of horn 402.

Horn 402, circuit 401, and apparatus 400 may be implemented within any suitable system and context. For example, horn 402, circuit 401, and apparatus 400 may be included fully or in part in a system, microcontroller, consumer device, electronic device, or any other suitable mechanism. Horn 402, circuit 401, and apparatus 400 may be included in, for example, a smoke detector, heat detector, carbon monoxide detector, alarm, security system, or any other context in which an audible response of horn 402 is to alert users to a condition. As such, horn 402 may be periodically tested to evaluate whether horn 402 is correctly functioning. Tests of whether horn 402 are correctly functioning may include tests of whether any terminals of horn 402 are short-circuits or are open (not connected to an expected electrical connection). In various examples, the tests of horn 402 in the present disclosure may be performed silently, wherein during the test, horn 402 may be verified to be working correctly without making an audible noise, which may be unexpected given that typical operation of horn 402 wherein a piezoelectric response is generated may, in normal operation and by design, cause an audible noise.

Control logic 410 may be connected to control circuitry 404. Control logic 410 may be configured to determine whether to silently test horn 402. The silent test of horn 402 may cause no audible noise when horn 402 is successfully working. Control logic 410 may be configured to, based upon a determination to silently test horn 402, with control circuitry 404, drive horn 402 with a ramped voltage. Horn 402 may be silent while being driven with the ramped voltage during the silent test mode. The ramped voltage may have a rise time or a slope that is slower than a resonant period of horn 402, resulting in a longer rise time than the resonant period. Control logic 410 may be configured to, based upon a determination to silently test horn 402, with control circuitry 404, evaluate whether or not horn 402 is working properly correctly based upon an output signal received from a test circuit 406, which in turn may be based upon an output signal received from horn 402.

Test circuit 406 may be implemented in any suitable manner, such as by analog circuitry, digital circuitry, control logic, instructions in a non-transitory medium (not shown) for execution by a processor (not shown), digital logic circuits programmed through hardware description language, ASICs, FPGAs, PLDs, or any suitable combination thereof, whether in a single unit or spread over several units.

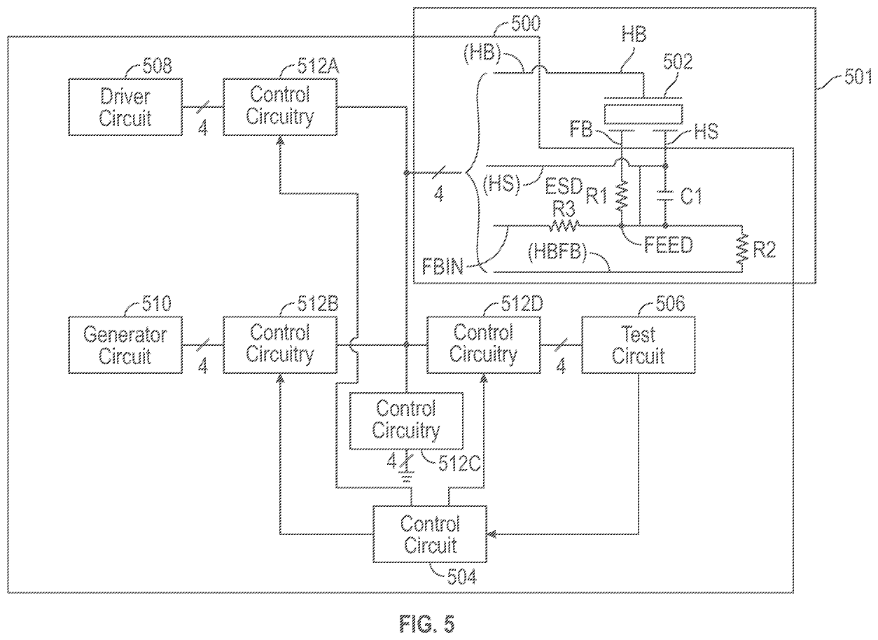

FIG. 5 is an illustration of an apparatus 500 for detection of open or short connections to a piezoelectric device, according to examples of the present disclosure.

Apparatus 500 may include a control circuit 504, a test circuit 506, a driver circuit 508, and a generator circuit 510. Moreover, apparatus may include any suitable number and kind of control circuitry 512 instances, such as control circuitry 512A, 512B, 512C, and 512D. Each instance of control circuitry 512 may be stand-alone or may be integrated within respective portions of apparatus 500, such as within respective ones of test circuit 506, driver circuit 508, and generator circuit 510. Control circuit 504 may include control logic (not shown). Each of control circuit 504, control logic in control circuit 504, test circuit 506, driver circuit 508, generator circuit 510, and control circuitry 512 may be implemented in any suitable manner, such as by analog circuitry, digital circuitry, control logic, instructions in a non-transitory medium (not shown) for execution by a processor (not shown), digital logic circuits programmed through hardware description language, ASICs, FPGAs, PLDs, or any suitable combination thereof, whether in a single unit or spread over several units.

Apparatus 500 may implement, fully or in part, one or more of apparatuses 100, 200, 300, 400 of FIGS. 1-4. Control circuit 504 may implement, fully or in part, one or more of control circuits 104, 204, control logics 310, 410, or control circuitries 304, 404 of FIGS. 1-4. Test circuit 504 may implement, fully or in part, one or more of test circuits 106, 206, 306, 406 of FIGS. 1-4. Control circuitry 512 may implement, fully or in part, control circuitry 304, 404, or control circuitry 304, 404 may implement, fully or in part, control circuitry 512.

Apparatus 500 may be configured to detect open or short connections to any suitable piezoelectric device. The piezoelectric device may include any suitable device for generating sound using a piezoelectric response or effect. The piezoelectric response may arise from electric charge accumulating in a solid material, which may include a linear electromechanical interaction between mechanical and electrical states in the material of the device without inversion symmetry. The voltage arising from the accumulation of charge may be converted in the piezoelectric device to mechanical movement of a metallic diaphragm. The piezoelectric device may be implemented by, for example, a piezoelectric horn 502.

Piezoelectric horn 502 may be implemented within a piezoelectric horn circuit 501, which may include any other suitable connections or components, as discussed in further detail below. Such components may be used, for example, for the conditioning of signals to or from horn 502. Circuit 501 may implement, fully or in part, one or more of circuits 101, 201, 301, 401.

Piezoelectric horn 502, circuit 501, or apparatus 500 may include any suitable number and kind of terminals, such as an HB terminal, an HS terminal, a FB terminal, and an FBIN terminal. An HBFB terminal may be interface to horn 502 but may exist outside of horn 502. Horn 502 may implement, fully or in part, horns 102, 202, 302, 402 of FIGS. 1-4.

Horn 502, circuit 501, or apparatus 500 may include any suitable elements connected thereto for any suitable purpose, such as signal conditioning, voltage dividing, or stepping voltage up or down. Such elements may be included within horn 502, circuit 501, or apparatus 500. For example, the FB terminal of horn 502 may have a resistor R1 attached thereto between the FB terminal and other portions of apparatus 500 or circuit 501. R1 may have a value of 220 kiloohms. The HS terminal of horn 502 may have a capacitor C1 attached thereto between the HS terminal and other portions of apparatus 500 or circuit 501. C1 may have a value of 1 nanoFarads. A bottom terminal of R1 and C1, given as the FEED node, may be connected together to route the FB signal to apparatus 500. Further, between this junction of C1 and R1 (FEED) and apparatus 500, an electrostatic discharge (ESD) current limiting resistor R3 may be connected between a junction of R1 and C1 (FEED) and an internal terminal given as FBIN, and may have a value of 500 kiloohms. R1, C1, and R2 may form a feedback network. In one example, HBFB may be a separate connection through R2 from horn 502. In other examples, a connection from R2 may be made to HB. R1 and C1 may form a delay circuit to provide a phase shift to achieve operation at peak resonance. The values of R1 and C1 may be selected to create an approximately ¼ cycle delay based upon the peak resonant frequency of horn 502. R2 may provide a DC bias point to the FB. R3 may protect against electrostatic discharge. R3 may be used with clamps (not shown), wherein an outer clamp would clamp voltage from −10V to 23V, and an inner clamp may clamp at a diode drop below the supply voltage or horn driver supply. R3 may be connected between such clamps. R3 may limit current flow to the inner clamp. Furthermore, R3 may be used as a current limiting device when FB is driven, having a same value as R4 discussed below.

Horn 502 and apparatus 500 may be implemented within any suitable system and context. For example, horn 502 and apparatus 500 may be included fully or in part in a system, microcontroller, consumer device, electronic device, or any other suitable mechanism. Horn 502 and apparatus 500 may be included in, for example, a smoke detector, heat detector, carbon monoxide detector, alarm, security system, or any other context in which an audible response of horn 502 is to alert users to a condition. As such, horn 502 may be periodically tested to evaluate whether horn 502 is correctly functioning. Tests of whether horn 502 are correctly functioning may include tests of whether any terminals of horn 502 are short-circuits or are open (not connected to an expected electrical connection). In various examples, the tests of horn 502 in the present disclosure may be performed silently, wherein during the test, horn 502 may be verified to be working correctly without making an audible noise, which may be unexpected given that typical operation of horn 502 wherein a piezoelectric response is generated may, in normal operation and by design, cause an audible noise. In various examples, horn 502 and apparatus 500 may be implemented together in a system.

Control circuit 504 may be configured to selectively connect various portions of apparatus 500 to horn 502, or to selectively enable various portions of apparatus 500 to operate with horn 502. Control circuit 504 may be configured to selectively connect or enable various portions of 500 through use of control circuitry 512. Instances of control circuitry 512 may be implemented by any suitable switch, switch fabric, enable signals, settings, commands, control signals, or other suitable communication or control, Instances of control circuitry 512 may be controlled by control circuit 504. Instances of control circuitry 512 may be implemented in a stand-alone manner or within respective ones of driver circuit 508, generator circuit 510, and test circuit 506. For simplicity, control circuitry 512 may be illustrated as implemented by various switches that are controlled by control circuit 504. Control circuitry 512 instances may be configured to provide selective routing and control of individual lines or buses to terminals, such as to or from HB, HS, FBIN, and HBFB.

Control circuitry 512A may be configured to provide selective access to HB, HS, FBIN, and HBFB terminals of horn 502 to particular portions of driver circuit 508. Thus, control circuitry 512A may be configured to enable or disable portions of driver circuit 508 to access HB, HS, FBIN, and HBFB terminals, or to connect or disconnect portions of driver circuit 508 from HB, HS, FBIN, and HBFB terminals.

Control circuitry 512B may be configured to provide selective access to HB, HS, and FBIN terminals to particular portions of generator circuit 510. Thus, control circuitry 512B may be configured to enable or disable portions of generator circuit 510 to access HB, HS, and FBIN terminals, or to connect or disconnect portions of generator circuit 510 from HB, HS and FBIN terminals.

Control circuitry 512C may be configured to selectively ground HB, HS, and FBIN terminals of horn 502.

Control circuitry 512D may be configured to provide selective access to HB, HS, FBIN, and HBFB terminals to particular portions of test circuit 506. Thus, control circuitry 512A may be configured to enable or disable portions of test circuit 506 to access HB, HS, FBIN, and HBFB terminals, or to connect or disconnect portions of test circuit 506 from HB, HS, FBIN, and HBFB terminals.

Apparatus 500 may be configured to operate in a normal mode of operation or a silent test mode of operation. Control circuit 504 may determine whether to operate apparatus 500 in the normal mode of operation or in the silent test mode of operation. Control circuit 504 may be configured to make the determination of whether to operate in the normal mode or silent test mode based upon any suitable criteria, such as user input, periodically, upon a remote software command from another system, as part of a larger diagnostic test, or upon a detected criterion. In the silent test mode, horn 502 may be silent for the duration of actions taken during the silent test mode, even if horn 502 is operating or functioning correctly. In the normal mode, horn 502 may make an audible noise if activated based upon a set criterion, such as detection of heat, smoke, carbon monoxide, intrusion, or other suitable stimulus.

Any suitable error may be detected during the silent test mode of horn 502. For example, short circuits across the HB and FB pins, across the HB and HS pins, or across the HS and FB pins may be detected. Moreover, open connections from the HB, HS, or FB pins may be detected.

Driver circuit 508 may be configured to drive horn 502 in the normal operation mode. Driver circuit 508 may include any suitable contents to cause horn 502 to make an audible noise if activated based upon a set environmental criterion. Control circuit 504 may be configured to enable driver circuit 508 during the normal operation mode and disable driver circuit 508 during the silent test mode. Control circuit 504 may enable or disable driver circuit through control circuitry 512A.

Generator circuit 510 may be configured to drive horn 502 in the silent test mode. Generator circuit 510 may be configured to provide a ramped voltage. The slope of the ramped voltage may be limited based upon the resonant period or frequency of horn 502. The slope of the ramped voltage may be sufficient to cause a piezoelectric response from horn 502 on an undriven terminal, but insufficient to cause horn 502 to generate an audible noise or sound. An undriven terminal may include one of HB, HS, FBIN, or FB pins that is neither applied to generator circuit 510 nor grounded. The rise time of the ramped voltage may be slower than a resonant period of horn 502. Generator circuit 510 may be implemented by, for example, a current limited source. The current limited source may include, for example, an op-amp with a series of resistance of 500 kilohms. Because horn 502 may have intrinsic capacitance (such as capacitance on the order of nano Farads (nF)), current limiting the driving source of generator circuit 510 may produce a slow voltage ramp, as opposed to a sharp step, to horn 502. This slow ramp may be used to prevent sustained oscillations or vibrations. If the ramp edge was much faster than the resonant period of horn 502, even a single step of the ramp that was, for example, hundreds of mV in magnitude may produce a damped ringing which can be audible. However, a ramp edge that is sufficiently slow (with a rise time slower than the resonant period) might not produce any audible response even if the overall voltage rise was large. By, for example, driving one terminal connected to horn 502, grounding a second terminal connected to horn 502, and sensing a third, undriven terminal 502 for piezoelectric response, a measure of the piezoelectric response may be made. The measure of the piezoelectric response may be used to determine opens and shorts. The measurement may be performed by comparison with a predetermined reference or threshold. This may be in contrast to other measurement techniques that, for example, measure impedance of horn 502.

The operation of slowly ramped voltage may prevent a case wherein, if a single voltage step is applied to the disc with a rise time less than the resonant period of horn 502 (that is, the step has a high slope or is rising quickly), the change in electric field may will produce a deflection in the disk, which initiates a repetitive exchange of electrical and mechanical energy. The effect may be a damped electrical ringing or mechanical vibration which produces a sound. A single such voltage step may cause a click, while multiple such voltage steps may cause a ringing. As the step time is increased, the rise time may be reduced, and the magnitude of the ringing, and of the sound, may decrease until the ringing is no longer evident and the sound becomes inaudible as the rise time becomes greater than the resonant period of horn 502. For example, for a horn 502 implemented by a Ningbo East EFM-290ED horn with a resonance frequency of 3.4 kHz, the resonant period may be 294 us. With HB driven and HS grounded, the ramp rate to prevent an audible response may be approximately 1.3 ms per 1V of input. A ramp rate faster than may risk some level of audibility.

Although shown as separately implemented, driver circuit 508 and generator circuit 510 may be implemented in a same circuit, which may be configured to selectively employ a normal mode or a test mode as determined by control circuit 504.

Test circuit 506 may be configured to receive output signals from horn 502. Test circuit 506 may be enabled by control circuit 504 when in silent test mode. Test circuit 506 may be optionally disabled by control circuit 504 when in normal mode.

When in standby, if no test mode or normal mode is enabled, both HS and HB may be pulled to ground. When driver circuit 508 is enabled in, for example, the normal mode, driver circuit 508 may pull HB high. This in turn may cause FEED to move in a positive direction. This FEED signal may be delayed by the feedback network (R1, C1, R2) but after some delay causes the FBIN input of the NAND gate 604 of driver circuit 508 (discussed in more detail below) to go high. This may cause driver circuit 508 to pull HS high and HB low. This may reverse the movement on FEED, which is again delayed through the feedback network and may cause a negative transition at FBIN at the input of NAND gate 604. This may cause the driver to pull HB high and HS low, and then the process repeats.

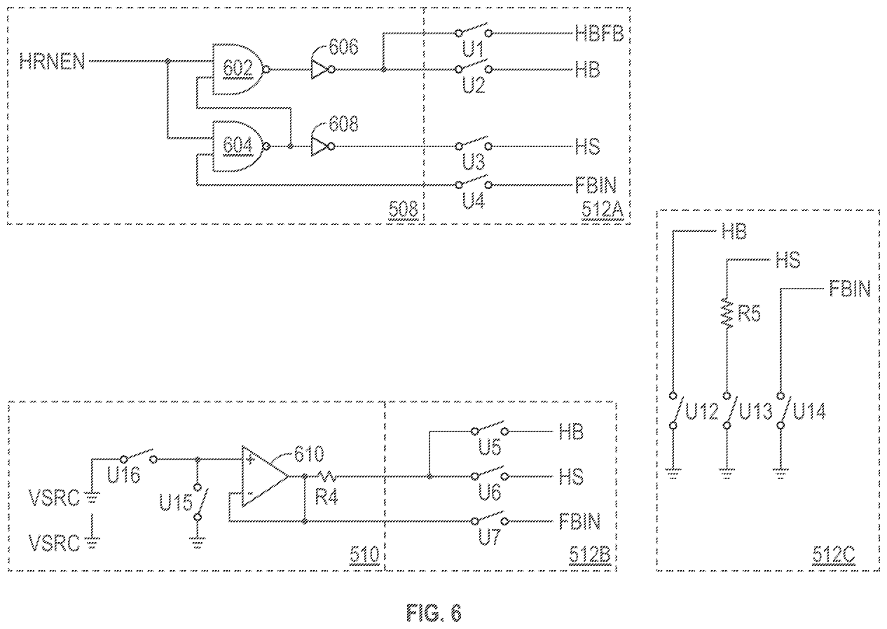

FIG. 6 is a more detailed illustration of example implementations of driver circuit 508, generator circuit 510, and control circuitry 512A, 512B, 512C, according to examples of the present disclosure.

Driver circuit 508 may receive a HRNEN signal to activate horn 502. Driver circuit 508 may include first and second NAND gates 602, 604. Signal HRNEN may be routed to a first input of each of first and second NAND gates 602, 604. An output of the second NAND gate 604 may be routed to a second input of the first NAND gate 602. Inverters 606, 608 may be respectively coupled to the output of each of first and second NAND gates 602, 604. The output of first inverter 606 may be selectively enabled or connected to the HBFB terminal connected to horn 502 and selectively connected to the HB terminal. The output of second inverter 608 may be selectively enabled or connected to the HS terminal. The second input of second NAND gate 604 may be selectively enabled or connected to the FBIN terminal.

Driver circuit 508 may be implemented fully or in part by, for example, a RE46C420, RE46C100, or RE46C101 device from Microchip Technologies, Inc., of Chandler, Ariz. Driver circuit 508 may include additional components, not shown.

The selective enablement or connections between these parts of driver circuit 508 and various terminals may be provided by control circuitry 512A. The ability of control circuitry 512A to provide the selective enablement or connections may be represented by ideal switches, though any suitable switch, tri-state switch, switch fabric, relay, control signals, transistor, or other suitable mechanism may be used.

For example, connection to the HBFB terminal may be selectively enabled by switch U1, such that when switch U1 is closed, the output of inverter 606 is connected to terminal HBFB. Connection to the HB terminal may be selectively enabled by switch U2, such that when switch U2 is closed, the output of inverter 606 is connected to terminal HB. Connection to the HS terminal may be selectively enabled by switch U3, such that when switch U3 is closed, the output of inverter 608 is connected to terminal HS. Connection to the FBIN terminal may be selectively enabled by switch U4, such that when switch U4 is closed, the second input of second NAND gate 604 is connected to terminal FBIN. Control circuit 504 may control these switches.

Generator circuit 510 may include an op-amp 610. A non-inverting input of op-amp 610 may be selectively connected to a power source Vsrc or ground. Vsrc may be, for example, 0.9V. The selective connection may be provided by any suitable mechanism, represented by ideal switches U16, U15. Output of op-amp 610 may be routed to its inverting input and selectively to the FBIN terminal. Output of op-amp 610 may also be routed through a resistor R4, which may have a value of 500 kiloohms, and then selectively to the HS terminal or selectively to the HB terminal.

The selective enablement or connections between these parts of generator circuit 510 and various terminals may be provided by control circuitry 512B. The ability of control circuitry 512B to provide the selective enablement or connections may be represented by ideal switches, though any suitable switch, tri-state switch, switch fabric, relay, control signals, transistor, or other suitable mechanism may be used.

For example, connection of the output of op-amp 610 to the HB terminal, through resistor R4, may be selectively enabled by switch U5. Connection of the output of op-amp 610 to the HS terminal, through resistor R4, may be selectively enabled by switch U6. Connection of the output of op-amp 610 to the FBIN terminal may be selectively enabled by switch U7. Control circuit 504 may control these switches.

Selective grounding of various terminals may be provided by control circuitry 512C. The ability of control circuitry 512C to provide the selective grounding may be represented by ideal switches, though any suitable switch, tri-state switch, switch fabric, relay, control signals, transistors, or other suitable mechanism may be used.

For example, the HB terminal may be selectively grounded by switch U12. Selective grounding of the HS terminal may be selectively enabled by switch U13. Selective grounding of the HS terminal through selective enablement by switch U13 may include a grounding through resistor R5, which may have a value of 500 kiloohms. Selective grounding of the FBIN terminal may be selectively enabled by switch U14. Control circuit 504 may control these switches.

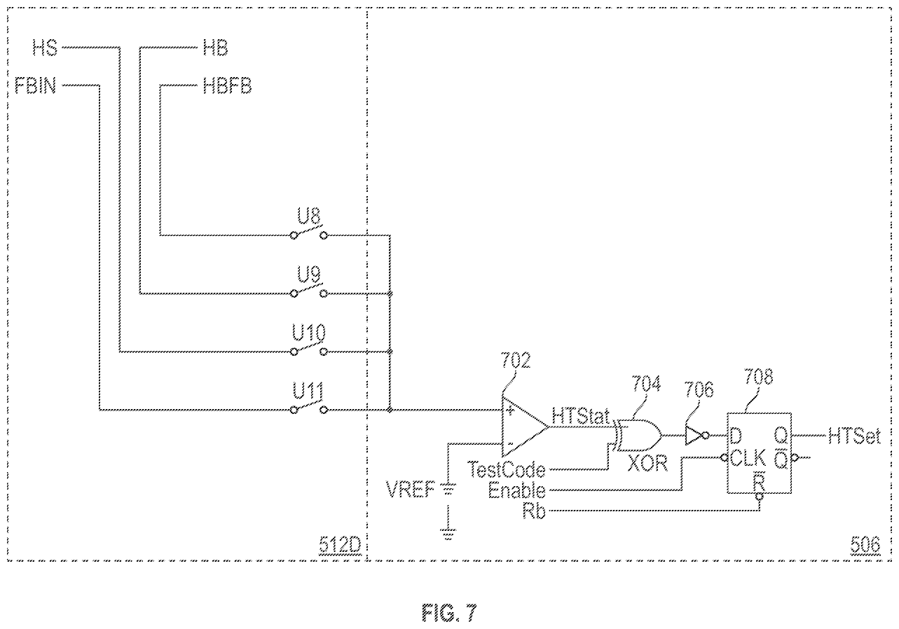

FIG. 7 is a more detailed illustration of example implementations of test circuit 506 and control circuitry 512D, according to examples of the present disclosure.

Test circuit 506 may include any suitable analog circuitry, digital circuitry, control logic, instructions in a non-transitory medium (not shown) for execution by a processor (not shown), digital logic circuits programmed through hardware description language, ASICs, FPGAs, PLDs, or any suitable combination thereof, whether in a single unit or spread over several units, to evaluate operation of outputs of the system.

Test circuit 506 may include a comparator 702. Comparator 702 may be configured to generate an output, given as HTSTAT. Comparator 702 may be configured to compare a selected one of inputs from the HBFB terminal, the HB terminal, the HS terminal, or the FBIN terminal against a reference voltage such as VREF. VREF may be, for example, 0.36V. The selected one of inputs from the HBFB terminal, the HB terminal, the HS terminal, or the FBIN terminal may be referred to as HTmeas.

Test circuit 506 may include an XOR gate 704. XOR gate 704 may include an input from comparator 702 in the form of the signal HTSTAT. XOR gate 704 may include another input in the form of a test code (TestCode), discussed in more detail below. In one example, the least significant bit (LSB) of the test code may be used.

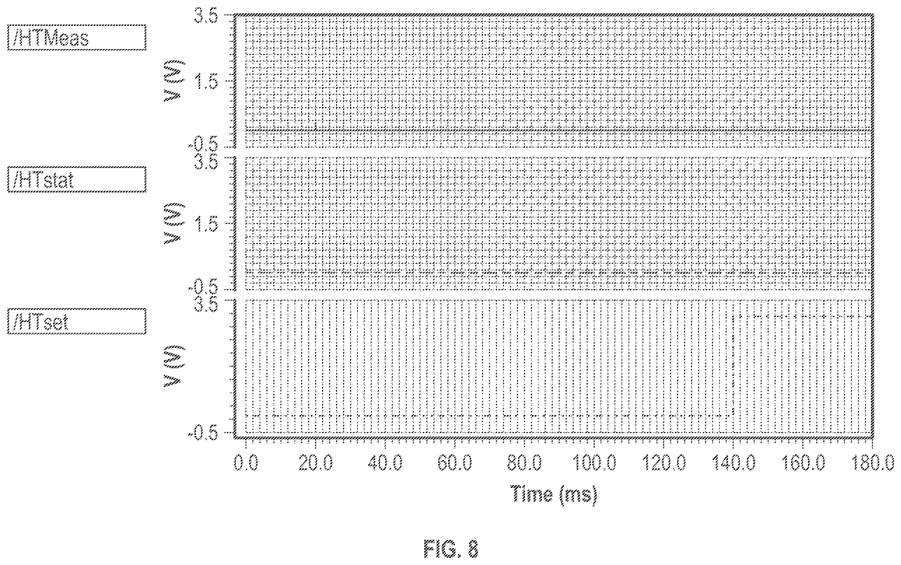

Test circuit 506 may include an inverter 706 to receive the output of XOR gate 704. Test circuit 506 may include a latch 708 or flip-flop. Latch 708 may receive output of inverter 706 on its D input and an enable signal on its clock. The Q output of latch 708 may be provided to control circuit 504 and may be given as HTSet. A logic-low reset input may be connected to an input signal given as Rb. Test circuit 506, alone or under direction by control circuit 504, may initiate a test sequence by enabling a test mode, selecting a test code, and switching enable to a logic high. This may be performed at, for example, t=40 ms as shown in FIGS. 8-19. This may also enable any current source or ramp. An amount of time may elapse, such as until t=140 ms. Once a negative transition occurs on the enable pin of latch 708, a test stimulus of a forced current may be removed. Latch 708 may then output the result at HTSet. HtSet may be a success or failure signal, with a success shown by a logic high value. After the output is read by, for example, control circuit 504, a reset pulse may be applied through Rb and the next test code may be selected and the process repeats until all tests have been completed.

XOR gate 704 and inverter 706 may have the effect of inverting the output of comparator 702 output whenever the signal TestCode[0] is low. This may be performed so as to always produce a high signal at HTSet for a passing test. This may the effect of confirming both that the test was run and that it was run successfully.

The selective enablement or connections between portions of test circuit 506 and the various terminals may be provided by control circuitry 512D. The ability of control circuitry 512D to provide the selective enablement or connections may be represented by ideal switches, though any suitable switch, tri-state switch, switch fabric, relay, control signals, transistors, or other suitable mechanism may be used.

For example, connection to the HBFB terminal may be selectively enabled by switch U8. Connection to the HB terminal may be selectively enabled by switch U9. Connection to the HS terminal may be selectively enabled by switch U10. Connection to the FBIN terminal may be selectively enabled by switch U11. Control circuit 504 may control these switches.

Control circuit 504 may cause one terminal to be driven, another terminal to be grounded, and then may measure the piezoelectric response of a third and undriven terminal to evaluate the integrity of terminals. The measurement may be performed by comparison with a predetermined reference or threshold.

Table 1 illustrates testing permutations and associated switch positions of FIGS. 4-7. An “x” may indicate that a given terminal is not tested in the given test. Each row of the table identifies whether the horn is being evaluated for a short or open condition. If a short is being tested, the terminal or terminals involved in the short are identified, as well as whether . If an open is being tested, the terminal with the open is identified. “Vss” may refer to ground and “Vdd” may refer to a power supply (not shown) that may be used to power any suitable portion of the system.

TABLE 1

| | Test | | | | Test | |
|---|---|---|---|---|---|---|
| Test # | Type | FB | HB | HS | Code | Closed Switches |
| 1 | Short | to Vdd | x | x | 0100 | U5, U11, U13, U15 |
| 2 | Open | open | x | x | 0111 | U5, U11, U13, U16 |
| 3 | Open | x | open | x | 0111 | U5, U11, U13, U16 |
| 4 | Short | to Vss | x | x | 0111 | U5, U11, U13, U16 |
| 5 | Short | to HS | x | to FB | 0111 | U5, U11, U13, U16 |
| 6 | Short | x | to Vss | x | 0111 | U5, U11, U13, U16 |
| 7 | Short | x | to HS | to HB | 0111 | U5, U11, U13, U16 |
| 8 | Open | x | x | open | 1001 | U5, U10, U12, U16 |
| 9 | Short | x | x | to Vss | 1001 | U5, U10, U12, U16 |
| 10 | Short | x | x | to Vdd | 1010 | U5, U10, U12, U15 |
| 11 | Short | to HB | to FB | x | 1101 | U7, U8, U14, U16 |
| 12 | Short | x | to Vdd | x | 1110 | U5, U9, U12, U15 |

The Test Code column in Table 1 may reference a register value or other designation that specifies a comparison, switch configuration, or expected values from the test. Moreover, multiple tests may be performed with a same switch configuration, such as tests #2-#7, or #8-#9. Test #1 may test for a short between the FB terminal and Vdd. Switches U5, U11, U13, U15 may be closed for such a test by control circuit 504. Tests #2-#7 may test for an open FB terminal, an open HB terminal, a short from the FB terminal to Vss, or a short between the HB terminal and the HS terminal. Switches U5, U11, U13, U16 may be closed for such tests. For each of the unique tests, #2-#7, failing a single of such tests may yield a same result as failing another one of such tests. Tests #8-#9 may test for an open HS terminal or a short from the HS terminal to Vss. Switches U5, U10, U12, U16 may be closed for such tests. For each of such tests, failing a single of such tests may yield a same result as failing another one of such tests. Test #10 may test for a short between the HS terminal and Vdd. Switches U5, U10, U12, U15 may be closed for such a test. Test #11 may test for a short from the FB terminal to the HB terminal. Switches U7, U8, U14, U16 may be closed for such a test. Test #12 may test for a short from the HB terminal to Vdd. Switches U5, U9, U12, U15 may be closed for such a test.

FIGS. 8-19 illustrate example plots of tests to be performed by apparatus 500 on horn 502. Illustrated in each are HTMeas (input to comparator 702 to be compared against VREF) of test circuit 506, HTSTAT (output of comparator 702 of test circuit 506), and HTSet (an evaluation of output of comparator 702 against an expected value to indicate success (with a high voltage value) or failure (with a low voltage value) of the tests applied to horn 502). In these figures, the evaluation plot may switch high with a pulse to indicate a normal result that horn 502 is working properly, indicating no short or open terminals, and may be flat to indicate an error for horn 502, such as a short or open terminal.

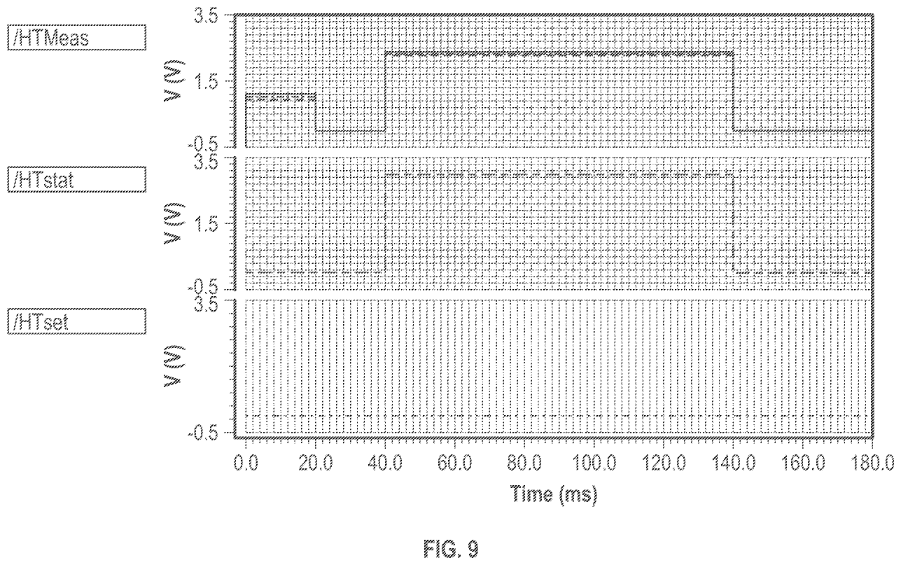

FIGS. 8 and 9 are illustrations of possible responses for test code 0100, according to examples of the present disclosure. This may correspond to test #1, a short between the FB terminal and Vdd. Switches U5, U11, U13, U15 may be closed for such a test by control circuit 504.

Accordingly, control circuit 504 may be configured to drive the HB terminal through the 500 kiloohm resistor of generator circuit 510 to 0V, as U5 and U15 are closed and U16 is open. The HS terminal may be grounded as U13 is closed, and the response of the FBIN terminal may be measured, which may include being compared with Vref since U11 is closed.

FIG. 8 illustrates results in this configuration when the FB terminal is not shorted to Vdd) and is working properly. In such a case, control circuit 504 may determine that horn 502 is working properly with respect to this test. FIG. 9 illustrates results in this configuration when the FB terminal is shorted to Vdd and is not working properly. In such a case, control circuit 504 may determine that horn 502 is not working properly. Control circuit 504 may evaluate that the expected response of FIG. 8 was not observed in FIG. 9, and thus an error was detected.

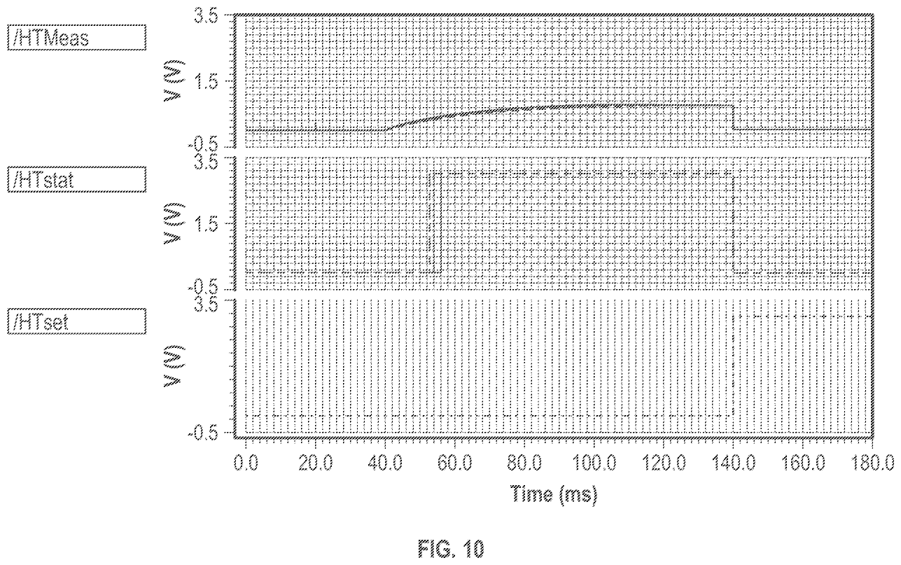

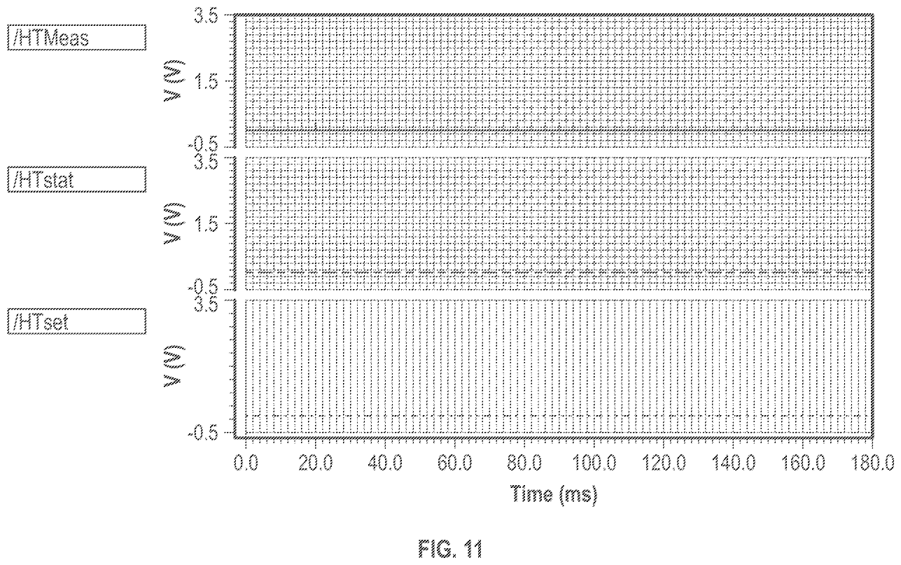

FIGS. 10 and 11 are illustrations of possible responses for test code 0111, according to examples of the present disclosure. This may correspond to tests #2-#7, which may include several different error conditions, including an open FB terminal, an open HB terminal, a short from the FB terminal to Vss, or a short between the HB terminal and the HS terminal. Switches U5, U11, U13, U16 may be closed for such tests by control circuit 504.

In these tests, control circuit 504 may be configured to use generator circuit 510 to drive the HB terminal through the 500 kiloohm resistor to the value of Vsrc (0.9V) since U5 and U16 are closed, to ground the HS terminal since U13 is closed, and to measure the FBIN terminal piezoelectric response through comparison with Vref, since U11 is closed.

FIG. 10 illustrates results in this configuration when horn 502 is working properly with respect to these tests. FIG. 11 illustrates the results in this configuration when any one of the tests fail, such as if the FB terminal is open there will be no drive provided to horn 502, or if the HB terminal is open there will be no drive provided to horn 502, or if the FB terminal is shorted to the HS terminal then the FB terminal will not pull up with a piezoelectric response, or if the FB terminal is shorted to Vss then the FB terminal will not exhibit a piezoelectric response, or if the HB terminal is shorted to the HS terminal then there will be no drive of the HB terminal, or if the HB terminal is shorted to Vss then there will be no drive of the HB terminal. FIG. 11 illustrates the operational results for any of these failures. Control circuit 504 may evaluate that the expected response of FIG. 10 was not observed in FIG. 11, and thus an error was detected.

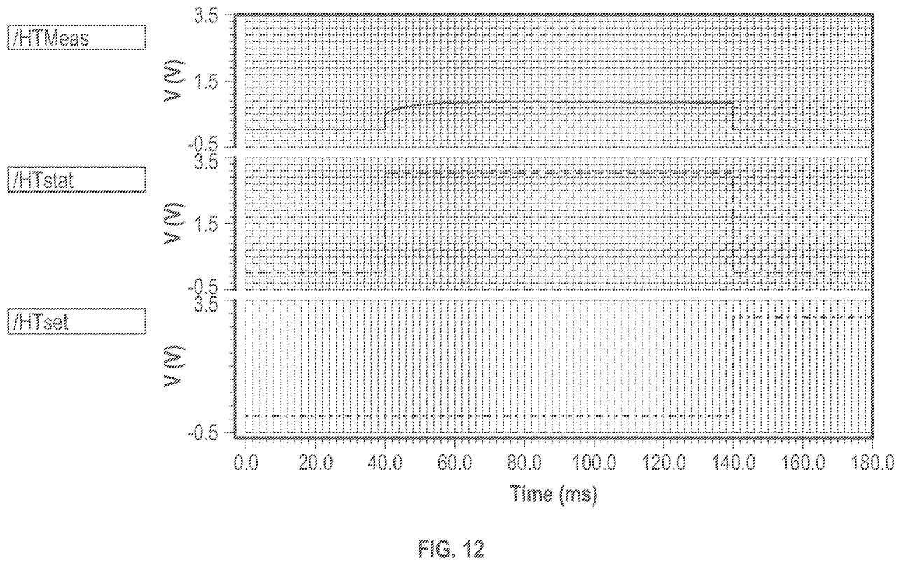

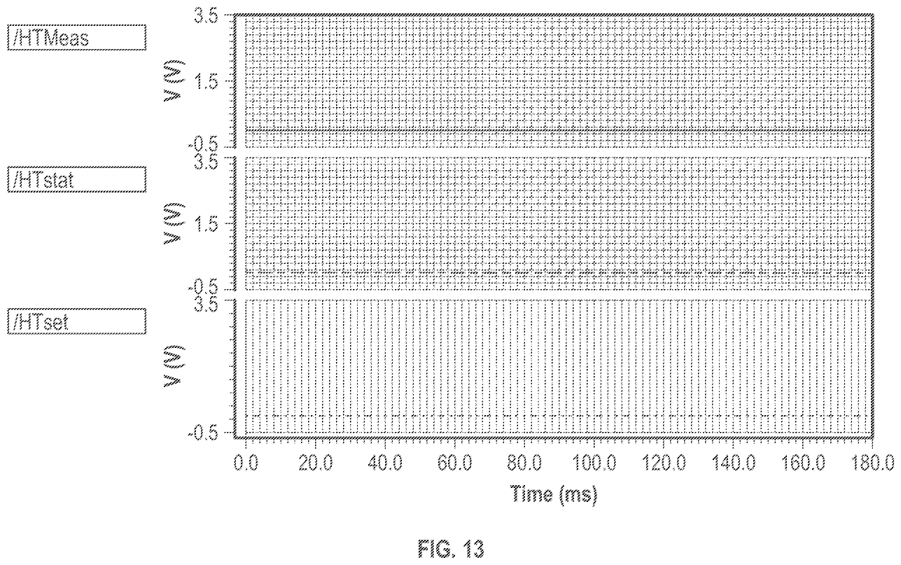

FIGS. 12 and 13 are illustrations of possible responses for test code 1001, according to examples of the present disclosure. This may correspond to tests #8-#9, which may include several different error conditions, including an open HS terminal or a short from the HS terminal to Vss. Switches U5, U10, U12, U16 may be closed for such tests.

In these tests, control circuit 504 may be configured to use generator circuit 510 to drive the HB terminal through the 500 kiloohm resistor to the value of Vsrc (0.9V), since U5 and U16 are closed, to ground the FEEDterminal through R3, since U14 is closed, and measure the piezoelectric response from the HS terminal through comparison with Vref since U10 is closed.

FIG. 12 illustrates results in this configuration when horn 502 is working properly with respect to these tests. FIG. 13 illustrates the results in this configuration when any of the tests fail, such as if the HB terminal is open then there will be no drive provided to horn 502, or if the HS terminal is shorted to Vss then the HS terminal will not pull up with a piezoelectric response. FIG. 13 illustrates the operational results for any of these failures. Control circuit 504 may evaluate that the expected response of FIG. 12 was not observed in FIG. 13, and thus an error was detected.

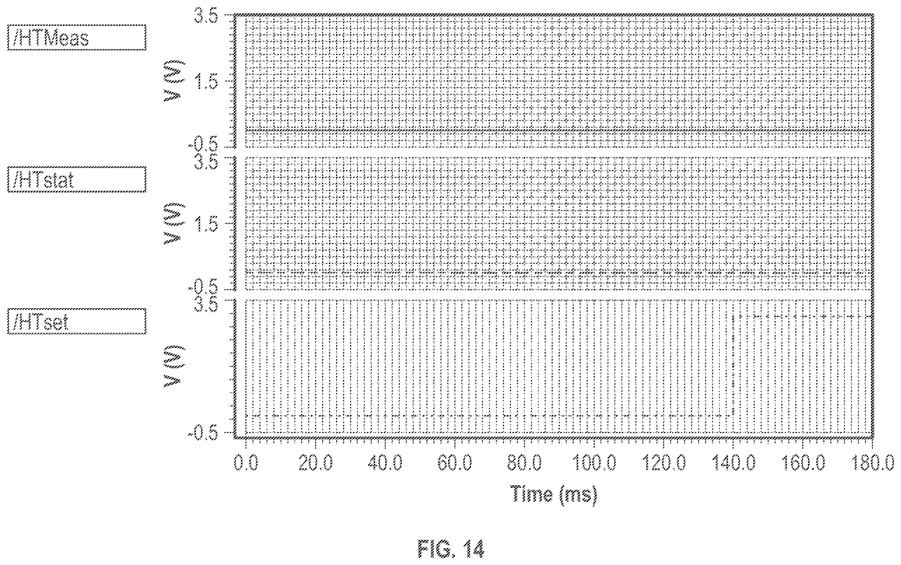

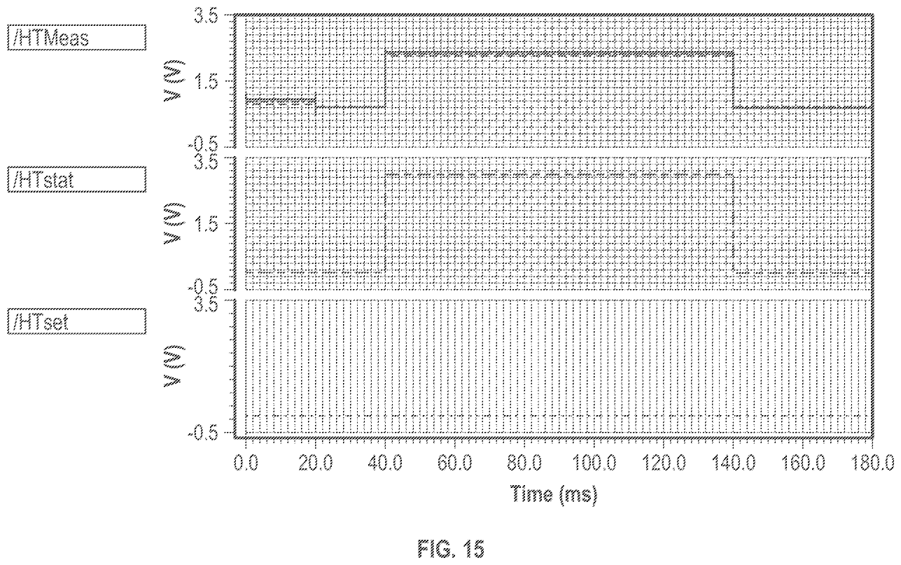

FIGS. 14 and 15 are illustrations of possible responses for test code 1010, according to examples of the present disclosure. This may correspond to test #10, which may test for a short between the HS terminal and Vdd. Switches U5, U10, U12, U15 may be closed for such a test.

In this test, control circuit 504 may be configured to use generator circuit 510 to drive the HB terminal through the 500 kiloohm resistor R4 to ground since U15 and U5 are closed, ground the FBIN terminal, and measure the response from the HS terminal through comparison with Vref, since U10 is closed. Op-amp 610 may be connected in a unity gain configuration, so its output may follow the non-inverting input which is connected to ground because U15 is closed, so the output will also be driven to ground. Because U5 is also closed, HB may be pulled to ground through the 500 kiloohm resistor R4 at the opamp output.

FIG. 14 illustrates this configuration horn 502 is working properly with respect to these tests. FIG. 15 illustrates the results in this configuration when the test fails, such as if the HS terminal is shorted to Vdd then the HS terminal will pull up to Vdd through the short with a response when none is expected. FIG. 15 illustrates the operational results for this failure. Control circuit 504 may evaluate that the expected response of FIG. 15 was not observed in FIG. 14, and thus an error was detected.

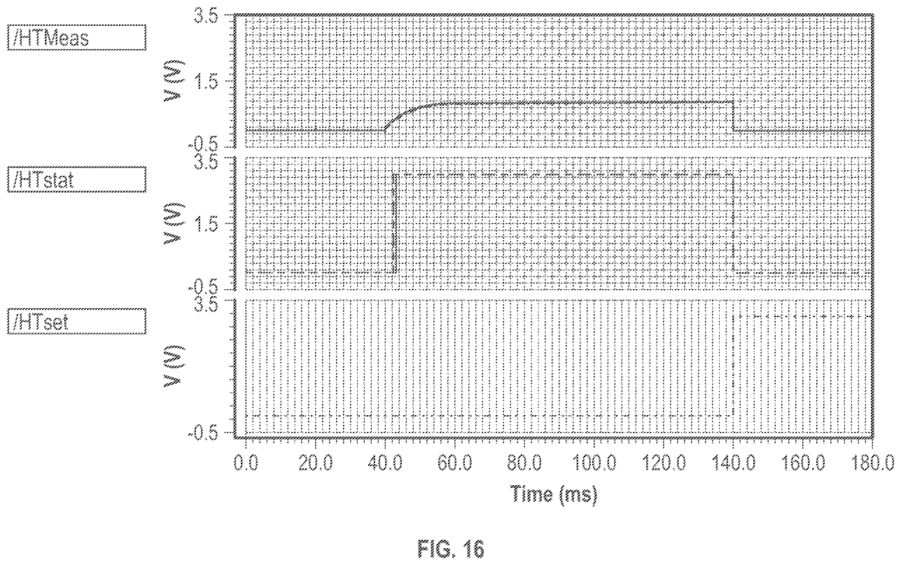

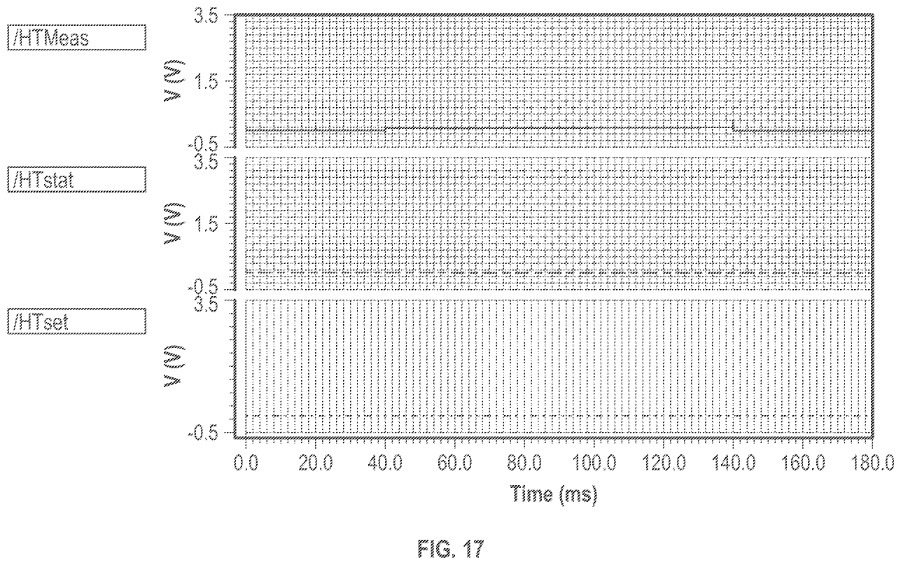

FIGS. 16 and 17 are illustrations of possible responses for test code 1101, according to examples of the present disclosure. This may correspond to test #11, which may test for a short from the FB terminal to the HB terminal. Switches U7, U8, U14, U16 may be closed for such a test.

In this test, control circuit 504 may be configured to use generator circuit 510 to drive the FEED terminal through the 500 kiloohm resistor R3 to Vsrc (0.9V), ground the HB terminal through U14, and measure HBFB, which may be an electrical measurement, which may be performed by comparing HBFB with Vref, since U8 is closed.

FIG. 16 illustrates this configuration horn 502 is working properly with respect to these tests. FIG. 17 illustrates the results in this configuration when the test fails, such as if the FB terminal is shorted to the HB terminal, then the HB terminal will not pull up. The 500 kiloohm resistor R3 on the FEED terminal bus may form a divider with R1 with feedback horn at the horn shorted to HB (ground). As HB is grounded and FB should be pulled up through R3, if FB is not shorted to HB then FEED will be free to pull up. However, if FB and HB are shored, then R3 and R1 may form a voltage divider. FEED may be sensed at HBFB through R2. Control circuit 504 may evaluate that the expected response of FIG. 16 was not observed in FIG. 17, and thus an error was detected.

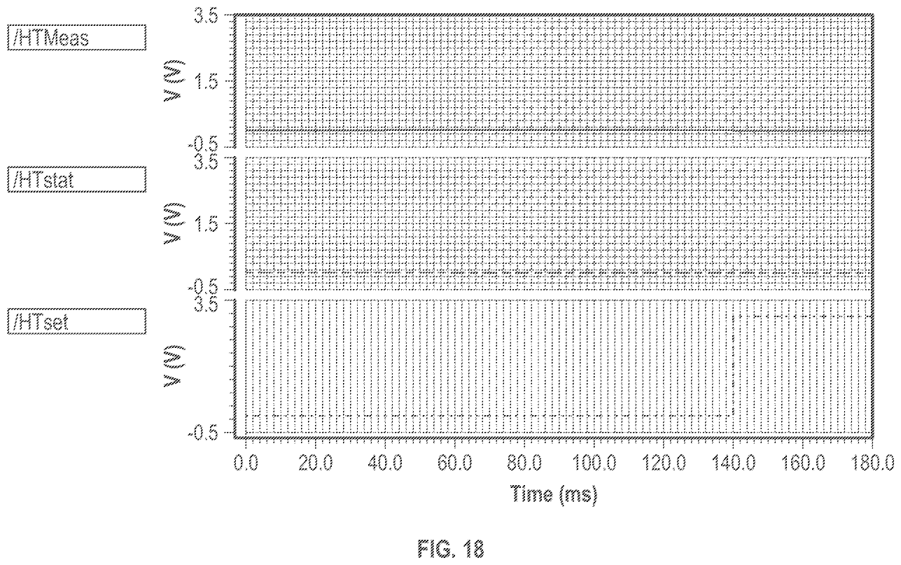

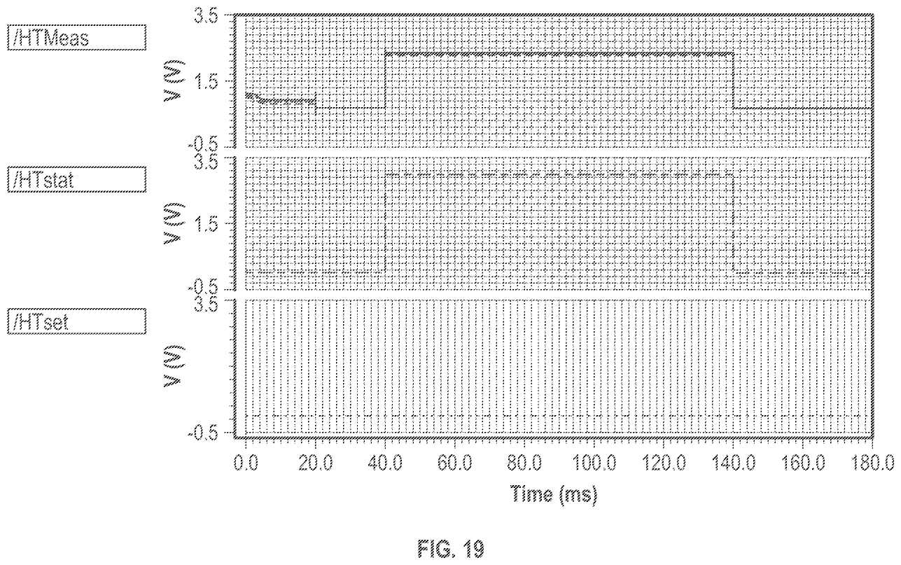

FIGS. 18 and 19 are illustrations of possible responses for test code 1110, according to examples of the present disclosure. This may correspond to test #12, which may test for a short from the HB terminal to Vdd. Switches U5, U9, U12, U15 may be closed for such a test. In this test, control circuit 504 may be configured to use generator circuit 510 to drive the HB terminal through the 500 kiloohm resistor to 0V, since U5 and U15 are closed, ground the FBIN terminal through op-amp 610 and R5, and measure the response from the HB terminal through comparison with Vref, since U9 is closed. FIG. 18 illustrates this configuration horn 502 is working properly with respect to these tests. FIG. 19 illustrates the results in this configuration when the test fails, such as if the HB terminal pulls high with a piezoelectric response if shorted to Vdd. Control circuit 504 may evaluate that the expected response of FIG. 18 was not observed in FIG. 19, and thus an error was detected.

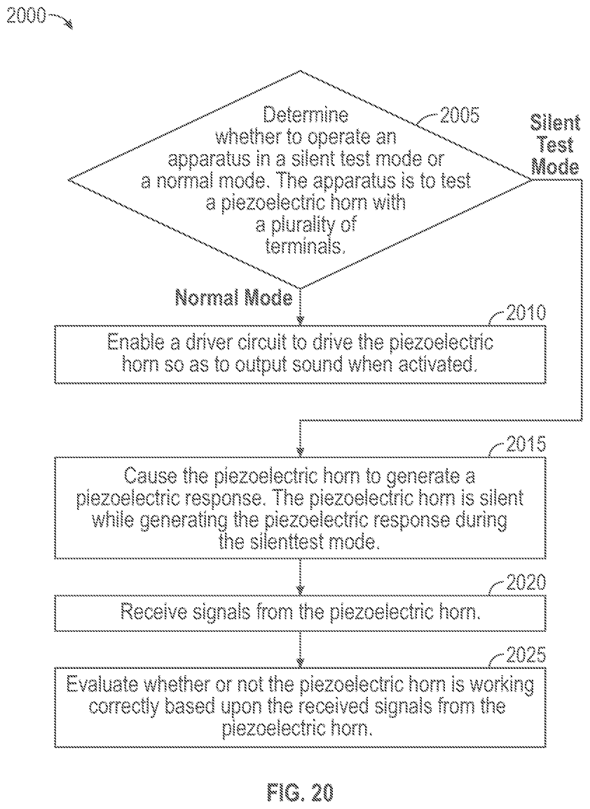

FIG. 20 is an illustration of operation of a method 2000 for detection of open or short connections to a piezoelectric device, according to examples of the present disclosure.

Method 2000 may be performed by any suitable mechanism, such as apparatuses 100, 200, 300, 400, 500, control circuits 104, 204, 504, control circuitry 304, 404, control logic 310, 410, test circuits 106, 206, 306, 406, 506, or any other suitable elements of FIGS. 1-5, or any suitable combination thereof. Method 2000 may begin at any suitable block and upon any suitable criteria. Method 2000 may optionally repeat. Method 2000 may be performed with fewer or more blocks than shown in FIG. 20. Moreover, blocks of method 2000 may be omitted, repeated, performed in parallel, performed in a different order than shown in FIG. 20, or performed recursively. One or more blocks of method 2000, although shown in an order, may be performed at the same time or in a reordered manner.

At 2005, it may be determined whether to operate an apparatus in a silent test mode or a normal mode. The apparatus may be configured to test a piezoelectric horn with a plurality of terminals. If the apparatus is to be operated in the normal mode, method 2000 may proceed to 2010. If the apparatus is to be operated in the silent test mode, method 2000 may proceed to 2015.

At 2010, a driver circuit may be enabled to drive the piezoelectric horn so as to output sound when the piezoelectric horn is activated in, for example, response to a determined environmental condition.

At 2015, the piezoelectric horn may be caused to generate a response. The piezoelectric horn may be silent while generating the piezoelectric response during the silent test mode.

At 2020, signals may be received from the piezoelectric horn.

At 2025, it may be evaluated whether or not the piezoelectric horn is working correctly based upon the received signals from the piezoelectric horn.

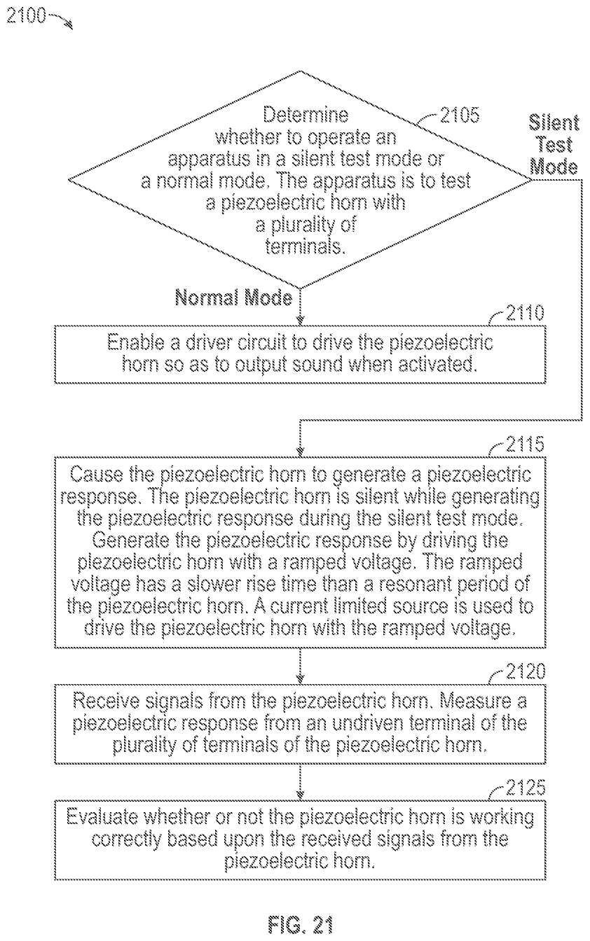

FIG. 21 is an illustration of operation of another method 2100 for detection of open or short connections to a piezoelectric device, according to examples of the present disclosure.

Method 2100 may implement, fully or in part, method 2000.

Method 2100 may be performed by any suitable mechanism, such as apparatuses 100, 200, 300, 400, 500, control circuits 104, 204, 504, control circuitry 304, 404, control logic 310, 410, test circuits 106, 206, 306, 406, 506, or any other suitable elements of FIGS. 1-5, or any suitable combination thereof. Method 2100 may begin at any suitable block and upon any suitable criteria. Method 2100 may optionally repeat. Method 2100 may be performed with fewer or more blocks than shown in FIG. 21. Moreover, blocks of method 2100 may be omitted, repeated, performed in parallel, performed in a different order than shown in FIG. 21, or performed recursively. One or more blocks of method 2100, although shown in an order, may be performed at the same time or in a reordered manner.

At 2105, it may be determined whether to operate an apparatus in a silent test mode or a normal mode. The apparatus may be configured to test a piezoelectric horn with a plurality of terminals. If the apparatus is to be operated in the normal mode, method 2000 may proceed to 2010. If the apparatus is to be operated in the silent test mode, method 2000 may proceed to 2015.

At 2110, a driver circuit may be enabled to drive the piezoelectric horn so as to output sound when the piezoelectric horn is activated in, for example, response to a determined environmental condition.

At 2115, the piezoelectric horn may be caused to generate a piezoelectric response. The piezoelectric horn may be silent while generating the piezoelectric response during the silent test mode. The piezoelectric response may be generated by driving the piezoelectric horn with a ramped voltage. The ramped voltage may have a slower rise time than a resonant period of the piezoelectric horn. A current limited source may be used to drive the piezoelectric horn with the ramped voltage.

At 2120, signals may be received from the piezoelectric horn. A piezoelectric response from an undriven terminal of the plurality of terminals of the piezoelectric horn may be measured. The measurement may be performed by comparison with a predetermined reference or threshold.

At 2125, it may be evaluated whether or not the piezoelectric horn is working correctly based upon the received signals from the piezoelectric horn.

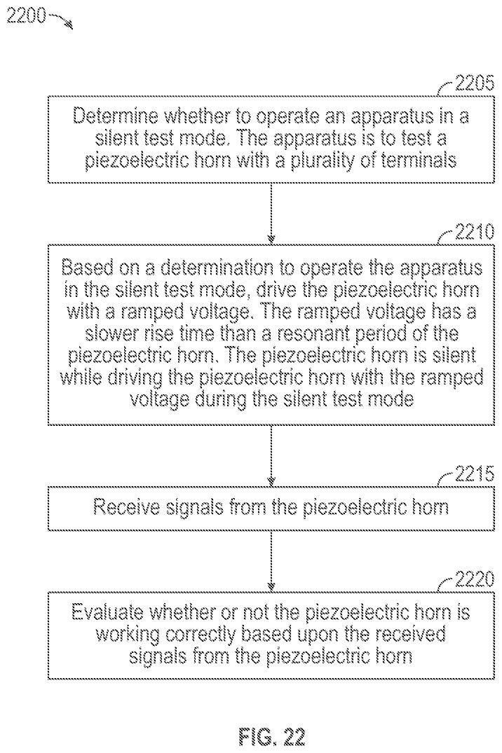

FIG. 22 is an illustration of operation of yet another method 2200 for detection of open or short connections to a piezoelectric device, according to examples of the present disclosure.

Method 2200 may be performed by any suitable mechanism, such as apparatuses 100, 200, 300, 400, 500, control circuits 104, 204, 504, control circuitry 304, 404, control logic 310, 410, test circuits 106, 206, 306, 406, 506, or any other suitable elements of FIGS. 1-5, or any suitable combination thereof. Method 2200 may begin at any suitable block and upon any suitable criteria. Method 2200 may optionally repeat. Method 2200 may be performed with fewer or more blocks than shown in FIG. 22. Moreover, blocks of method 2200 may be omitted, repeated, performed in parallel, performed in a different order than shown in FIG. 22, or performed recursively. One or more blocks of method 2200, although shown in an order, may be performed at the same time or in a reordered manner.

At 2205, it may be determined to operate an apparatus in a silent test mode. The apparatus may be configured to test a piezoelectric horn with a plurality of terminals.

At 2210, based on a determination to operate the apparatus in the silent test mode, the piezoelectric horn may be driven with a ramped voltage. The ramped voltage may have a slower rise time than a resonant period of the piezoelectric horn. The piezoelectric horn may be silent while driving the piezoelectric horn with the ramped voltage during the silent test mode.

At 2215, signals may be received from the piezoelectric horn.

At 2220, it may be evaluated whether or not the piezoelectric horn is working correctly based upon the received signals from the piezoelectric horn.

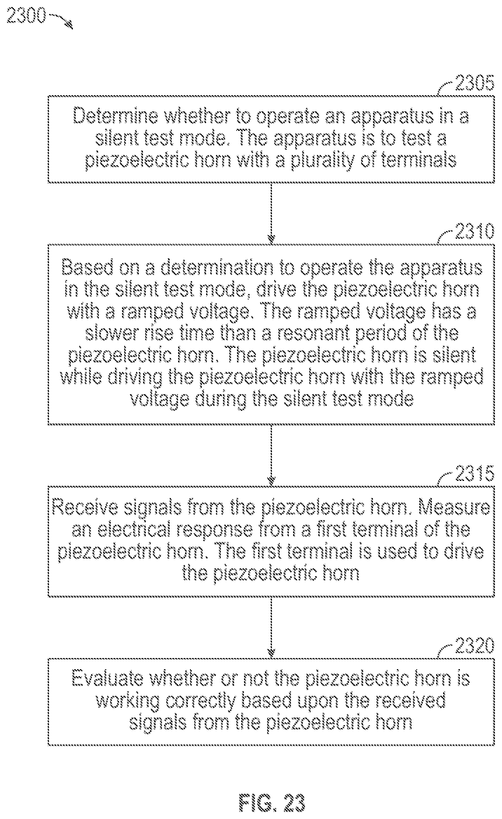

FIG. 23 is an illustration of operation of still another method 2300 for detection of open or short connections to a piezoelectric device, according to examples of the present disclosure.

Method 2300 may implement, fully or in part, method 2200.

Method 2300 may be performed by any suitable mechanism, such as apparatuses 100, 200, 300, 400, 500, control circuits 104, 204, 504, control circuitry 304, 404, control logic 310, 410, test circuits 106, 206, 306, 406, 506, or any other suitable elements of FIGS. 1-5, or any suitable combination thereof. Method 2300 may begin at any suitable block and upon any suitable criteria. Method 2300 may optionally repeat. Method 2300 may be performed with fewer or more blocks than shown in FIG. 23. Moreover, blocks of method 2300 may be omitted, repeated, performed in parallel, performed in a different order than shown in FIG. 23, or performed recursively. One or more blocks of method 2300, although shown in an order, may be performed at the same time or in a reordered manner.

At 2305, it may be determined to operate an apparatus in a silent test mode. The apparatus may be configured to test a piezoelectric horn with a plurality of terminals.

At 2310, based on a determination to operate the apparatus in the silent test mode, the piezoelectric horn may be driven with a ramped voltage. The ramped voltage may have a slower rise time than a resonant period of the piezoelectric horn. The piezoelectric horn may be silent while driving the piezoelectric horn with the ramped voltage during the silent test mode.

At 2315, signals may be received from the piezoelectric horn. In one example, an electrical response may be measured from a first terminal of the piezoelectric horn. The measurement may be performed by comparison with a predetermined reference or threshold. The first terminal may be used to drive the piezoelectric horn. In another example, a piezoelectric response from an undriven terminal may be measured.

At 2320, it may be evaluated whether or not the piezoelectric horn is working correctly based upon the received signals from the piezoelectric horn.

Examples of the present disclosure may include an apparatus. The apparatus may include a test circuit to receive signals from a piezoelectric horn. The apparatus may include a control circuit. The circuits may be implemented by analog circuitry, digital circuitry, control logic, instructions in a non-transitory medium (not shown) for execution by a processor (not shown), digital logic circuits programmed through hardware description language, application specific integrated circuits (ASIC), field programmable gate arrays (FPGA), programmable logic devices (PLD), or any suitable combination thereof, whether in a single unit or spread over several units. The control circuit may be to determine whether to operate the apparatus in a silent test mode or a normal mode. The control circuit may be to, based on a determination to operate in the normal mode, enable a driver circuit to drive the piezoelectric horn so as to output sound when activated by the driver circuit. The control circuit may be to, based on a determination to operate in the silent test mode, cause the piezoelectric horn to generate a piezoelectric response, wherein the piezoelectric horn is silent while generating the piezoelectric response during the silent test mode. The control circuit may be to, based on the silent test mode, cause evaluation of whether or not the piezoelectric horn is working correctly based upon the received signals from the piezoelectric horn.

In combination with any of the above examples, the control circuit may be to, in the silent test mode, cause the piezoelectric horn to generate the piezoelectric response by driving the piezoelectric horn with a ramped voltage. The ramped voltage with a slower rise time than a resonant period of the piezoelectric horn.

In combination with any of the above examples, the control circuit may be to, in the silent test mode, cause a current limited source to drive the piezoelectric horn with the ramped voltage.

In combination with any of the above examples, the current limited source may include an operational amplifier.

In combination with any of the above examples, the control circuit may be to, in the silent test mode, cause the piezoelectric horn to generate a piezoelectric response by selectively disabling a driver circuit, the driver circuit to drive the piezoelectric horn during the normal mode.

In combination with any of the above examples, the control circuit may be to, in the silent test mode, cause the test circuit to measure a piezoelectric response from an undriven terminal of the plurality of terminals of the piezoelectric horn.

In combination with any of the above examples, the control circuit may be to drive a first terminal of the plurality of terminals of the piezoelectric horn, ground a second terminal of the plurality of terminals of the piezoelectric horn, and cause the test circuit to measure the piezoelectric response from a third terminal of the plurality of terminals of the piezoelectric horn, wherein the third terminal is the undriven terminal of the plurality of terminals of the piezoelectric horn.

In combination with any of the above examples, the control circuit may be to drive the first terminal with respect to the second terminal that is grounded, and the test circuit may be to measure the piezoelectric response from the third terminal with respect to the second terminal that is grounded.

In combination with any of the above examples, the control circuit may be to, based on a determination to operate in the normal mode, disable a generator of the piezoelectric response for the silent test mode.

In combination with any of the above examples, the control circuit may be to determine that the piezoelectric horn is not working correctly based upon a determination from the received signals from the piezoelectric horn that a short circuit exists across two of the plurality of terminals.

In combination with any of the above examples, the control circuit may be to determine that the piezoelectric horn is not working correctly based upon a determination from the signals from the piezoelectric horn that any of the terminals are open.

Examples of the present disclosure may include an apparatus. The apparatus may include a test circuit to receive signals from a piezoelectric horn. The apparatus may include a control circuit to determine whether to operate the apparatus in a silent test mode, and, based on a determination to operate in the silent test mode, drive the piezoelectric horn with a ramped voltage, the ramped voltage with a slower rise time than a resonant period of the piezoelectric horn, wherein the piezoelectric horn is silent while driving the piezoelectric horn with the ramped voltage during the silent test mode, and cause evaluation of whether or not the piezoelectric horn is working correctly based upon the received signals from the piezoelectric horn.

In combination with any of the above embodiments, the test circuit may be to measure an electrical response from a first terminal of the plurality of terminals to evaluate whether or not the piezoelectric horn is working correctly, the first terminal used to drive the piezoelectric horn.

Examples of the present disclosure may include an apparatus. The apparatus may include control circuitry and control logic connected to the control circuitry, the control logic to determine whether to silently test a piezoelectric horn, the piezoelectric horn to include a plurality of terminals, the silent test of the piezoelectric horn to cause no audible noise when the piezoelectric horn is successfully working and, based upon a determination to silently test the piezoelectric horn, with the control circuitry, cause the piezoelectric horn to generate a piezoelectric response, and evaluate whether, or not, the piezoelectric horn is working correctly based upon an output signal received at a test circuit from the piezoelectric horn.

Examples of the present disclosure may include an apparatus with control circuitry and control logic connected to the control circuitry. The control logic may determine whether to silently test a piezoelectric horn. The piezoelectric horn may be to include a plurality of terminals, the silent test of the piezoelectric horn to cause no audible noise when the piezoelectric horn is successfully working and, based upon a determination to silently test the piezoelectric horn, with the control circuitry, drive the piezoelectric horn with a ramped voltage, the ramped voltage with a slower rise time than a resonant period of the piezoelectric horn, wherein the piezoelectric horn is silent while driving the piezoelectric horn with the ramped voltage during the silent test mode, and with the control circuitry, enable reception of an output signal from the piezoelectric horn and evaluate whether, or not, the piezoelectric horn is working correctly based upon the output signal received at the test circuit.

Although examples have been described above, other variations and examples may be made from this disclosure without departing from the spirit and scope of these examples.

We claim:

1. An apparatus, comprising:
a test circuit to receive signals from a piezoelectric horn, the piezoelectric horn to include a plurality of terminals; and
a control circuit to:
determine whether to operate the apparatus in a silent test mode or a normal mode;
based on a determination to operate in the normal mode, enable a driver circuit to drive the piezoelectric horn so as to output sound when activated by the driver circuit;
based on a determination to operate in the silent test mode:
cause the piezoelectric horn to generate a piezoelectric response, wherein the piezoelectric horn is silent while generating the piezoelectric response during the silent test mode; and
cause evaluation of whether or not the piezoelectric horn is working correctly based upon the received signals from the piezoelectric horn.

2. The apparatus of claim 1, wherein the control circuit is to, in the silent test mode, cause the piezoelectric horn to generate the piezoelectric response by driving the piezoelectric horn with a ramped voltage, the ramped voltage with a slower rise time than a resonant period of the piezoelectric horn.

3. The apparatus of claim 2, wherein the control circuit is to, in the silent test mode, cause a current limited source to drive the piezoelectric horn with the ramped voltage.

4. The apparatus of claim 3, wherein the current limited source includes an operational amplifier.

5. The apparatus of claim 1, wherein the control circuit is to, in the silent test mode, cause the piezoelectric horn to generate a piezoelectric response by selectively disabling a driver circuit, the driver circuit to drive the piezoelectric horn during the normal mode.

6. The apparatus of claim 1, wherein the control circuit is to, in the silent test mode, cause the test circuit to measure a piezoelectric response from an undriven terminal of the plurality of terminals of the piezoelectric horn.

7. The apparatus of claim 6, wherein the control circuit is to:
drive a first terminal of the plurality of terminals of the piezoelectric horn;
ground a second terminal of the plurality of terminals of the piezoelectric horn; and
cause the test circuit to measure the piezoelectric response from a third terminal of the plurality of terminals of the piezoelectric horn, wherein the third terminal is the undriven terminal of the plurality of terminals of the piezoelectric horn.

8. The apparatus of claim 7, wherein:
the control circuit is to drive the first terminal with respect to the second terminal that is grounded; and
the test circuit is to measure the piezoelectric response from the third terminal with respect to the second terminal that is grounded.

9. The apparatus of claim 1, wherein the control circuit is to, based on a determination to operate in the normal mode, disable a generator of the piezoelectric response for the silent test mode.

10. The apparatus of claim 1, wherein the control circuit is to determine that the piezoelectric horn is not working correctly based upon a determination from the received signals from the piezoelectric horn that a short circuit exists across two of the plurality of terminals.

11. The apparatus of claim 1, wherein the control circuit is to determine that the piezoelectric horn is not working correctly based upon a determination from the signals from the piezoelectric horn that any of the terminals are open.

12. An apparatus, comprising:
a test circuit to receive signals from a piezoelectric horn, the piezoelectric horn to include a plurality of terminals; and
a control circuit to determine whether to operate the apparatus in a silent test mode, and, based on a determination to operate in the silent test mode:
drive the piezoelectric horn with a ramped voltage, the ramped voltage with a slower rise time than a resonant period of the piezoelectric horn, wherein the piezoelectric horn is silent while driving the piezoelectric horn with the ramped voltage during the silent test mode; and
cause evaluation of whether or not the piezoelectric horn is working correctly based upon the received signals from the piezoelectric horn.

13. The apparatus of claim 12, wherein the test circuit is to measure an electrical response from a first terminal of the plurality of terminals to evaluate whether or not the piezoelectric horn is working correctly, the first terminal used to drive the piezoelectric horn.

14. A method, comprising:
determining whether to operate an apparatus in a silent test mode or a normal mode, the apparatus to test a piezoelectric horn with a plurality of terminals;
based on a determination to operate the apparatus in the normal mode, enabling a driver circuit to drive the piezoelectric horn so as to output sound when activated; and
based on a determination to operate the apparatus in the silent test mode:
causing the piezoelectric horn to generate a piezoelectric response, wherein the piezoelectric horn is silent while generating the piezoelectric response during the silent test mode;
receiving signals from the piezoelectric horn; and
evaluating whether or not the piezoelectric horn is working correctly based upon the received signals from the piezoelectric horn.

15. The method of claim 14, comprising, in the silent test mode, causing the piezoelectric horn to generate the piezoelectric response by driving the piezoelectric horn with a ramped voltage, the ramped voltage with a slower rise time than a resonant period of the piezoelectric horn.

16. The method of claim 15, comprising, in the silent test mode, causing a current limited source to drive the piezoelectric horn with the ramped voltage.

17. The method of claim 14, comprising, in the silent test mode, measuring a piezoelectric response from an undriven terminal of the plurality of terminals of the piezoelectric horn with the received signals.

18. A method, comprising:
determining whether to operate an apparatus in a silent test mode, the apparatus to test a piezoelectric horn with a plurality of terminals; and
based on a determination to operate the apparatus in the silent test mode:
driving the piezoelectric horn with a ramped voltage, the ramped voltage with a slower rise time than a resonant period of the piezoelectric horn, wherein the piezoelectric horn is silent while driving the piezoelectric horn with the ramped voltage during the silent test mode;
receiving signals from the piezoelectric horn; and
evaluate whether or not the piezoelectric horn is working correctly based upon the received signals from the piezoelectric horn.

19. The method of claim 18, comprising measuring an electrical response from a first terminal of the plurality of terminals to evaluate whether or not the piezoelectric horn is working correctly, the first terminal used to drive the piezoelectric horn.

20. An apparatus, comprising:
a control circuitry; and
control logic connected to the control circuitry, the control logic to:
determine whether to silently test a piezoelectric horn, the piezoelectric horn to include a plurality of terminals, the silent test of the piezoelectric horn to cause no audible noise when the piezoelectric horn is successfully working; and
based upon a determination to silently test the piezoelectric horn:
with the control circuitry, cause the piezoelectric horn to generate a piezoelectric response;
and
evaluate whether, or not, the piezoelectric horn is working correctly based upon an output signal received at a test circuit from the piezoelectric horn.

21. An apparatus, comprising:
a control circuitry; and
control logic connected to the control circuitry, the control logic to:
determine whether to silently test a piezoelectric horn, the piezoelectric horn to include a plurality of terminals, the silent test of the piezoelectric horn to cause no audible noise when the piezoelectric horn is successfully working; and
based upon a determination to silently test the piezoelectric horn:
with the control circuitry, drive the piezoelectric horn with a ramped voltage, the ramped voltage with a slower rise time than a resonant period of the piezoelectric horn, wherein the piezoelectric horn is silent while driving the piezoelectric horn with the ramped voltage during the silent test mode; and
with the control circuitry, enable reception of an output signal from the piezoelectric horn; and
evaluate whether, or not, the piezoelectric horn is working correctly based upon the output signal received at the test circuit.
